(19) United States
(12) Patent Application Publication
(10) Pub. No.: US 2010/0142971 A1
(43) Pub. Date: Jun. 10, 2010

(54) APPARATUS FOR SYNCHRONIZING DIGITAL SIGNALS OF COHERENT OPTICAL RECEIVER

(76) Inventors: Sun-hyok Chang, Daejeon-si (KR); Hwan-seok Chung, Daejeon-si (KR); Kwang-joon Kim, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/628,920

(22) Filed: Dec. 1, 2009

(30) Foreign Application Priority Data
Dec. 5, 2008 (KR) 10-2008-0123110
Mar. 30, 2009 (KR) 10-2009-0027027

(51) Int. Cl. H04B 10/00; H04B 10/06

(52) U.S. Cl. 398/154; 398/208

(57) ABSTRACT

Provided is a digital signal synchronization device of a coherent optical receiver. The digital signal synchronization device includes a digital signal processing unit to perform synchronization on a digital signal of an output optical signal generated by interfering an optical signal received through an optical fiber with an optical signal of laser output from a local oscillator and to perform decoding using the synchronized digital signal, and a digital signal managing unit to monitor the digital signal processing unit to output data of the optical signal normally, which has been received through the optical fiber, according to the synchronized digital signal.

### CROSS REFERENCE TO RELATED APPLICATIONS

This application claims the benefit under 35 U.S.C. §119(a) of Korean Patent Application Nos. 10-2008-0123110 filed on Dec. 5, 2008, and 10-2209-0027027, filed on Mar. 30, 2009, the disclosures of which are incorporated by reference herein for all purposes.

### BACKGROUND

1. Field

The following description relates to an optical transmission technology, and more particularly, to a digital synchronization apparatus of a coherent optical receiver.

2. Description of the Related Art

A coherent optical transmission technology which was first introduced in 1980's attempted to implement an optical phase-locked loop (PLL) or an optical polarization controller in an optical domain in order to control optical phase and optical polarization of an optical receiver, but could not yield expected results in terms of efficiency and practicability.

In the early 1990's, with the advent of Erbium-doped fiber amplifier (EDFA), techniques for an optical communication system were widely studied and the commercialization was attempted actively, whereas the researches on coherent optical communications has decreased since then. However, recently with the development of integrated circuit and digital signal processing (DSP), interest in the study of coherent optical communications has increased. The recent coherent optical communication technology using DSP has much similarity to the radio frequency (RF)/wireless communication technology. Accordingly, the coherent optical communication technology has been remarkably improved in last few years by combining therewith the RF/wireless communication technology developed for several tens of years.

A coherent optical receiver compensates for impairments in a digital manner, the impairments including chromatic dispersion and polarization mode dispersion (PMD) in optical fibers. The coherent optical receiver has higher receiver sensitivity and is more robust against noise components such as amplified spontaneous emission (ASE), compared to a conventional technology, and thus various studies thereon have been conducted.

Meanwhile, a conventional coherent optical receiver controlling a variety of polarizations and phases uses a digital adaptive equalizer to compensate for impairments including chromatic dispersion and PMD in optical fibers.

Another conventional coherent optical receiver uses a digital phase estimator or a digital phase-locked loop (PLL) to compensate for a laser phase difference between laser from a local oscillator (LO) and a received optical signal.

A general coherent optical receiver reproduces a clock signal from a received optical signal for synchronization of the received optical signal and reproduces the received optical signal using the reproduced clock signal. That is, in the synchronization of the coherent optical receiver, clock reproduction is performed in an analog or a digital manner, and the reproduced clock drives a sampler to reproduce the received optical signal.

As such, since the configuration of the conventional coherent optical receiver for synchronization of an incoming signal is complex and symbol rate available for the synchronization is limited, its implementation in practice is very difficult.

### SUMMARY

Accordingly, in one aspect, there is provided a coherent optical receiver which improves its digital signal synchronization function to allow the synchronization in a wider range of symbol rates.

In one general aspect, there is provided a digital signal synchronization device including a digital signal processing unit to perform synchronization on a digital signal of an output optical signal generated by interfering an optical signal received through an optical fiber with an optical signal of laser (hereinafter, referred to as a laser optical signal) output from a local oscillator and to perform decoding using the synchronized digital signal, and a digital signal managing unit to monitor the digital signal processing unit to output data of the optical signal normally, which has been received through the optical fiber, according to the synchronized digital signal.

The digital signal processing unit may include a frequency offset estimator to compensate the digital signal for a frequency difference between the optical signal received through the optical fiber and the laser optical signal and to combine the compensated digital signals, a digital synchronizer to synchronize the compensated and combined digital signal, and a decoder to decode the digital signal with reference to the synchronized digital signal.

The digital signal processing unit may further include an optical fiber impairment compensator to check whether the digital signal generated from the optical signal received through the optical fiber has impairment due to impairment components in the optical fiber and compensate for the impairment according to the check result.

The digital signal managing unit may include a digital signal detector to check whether the synchronized digital signal is decoded normally and to control operations of the decoder according to the check result, and an initial condition setter to initialize a predefined condition of the digital signal synchronizer when the check result indicates that the decoding has been performed abnormally.

The digital signal managing unit may include a digital signal detector to determine stability of the synchronized digital signal with reference to a changed parameter of the digital signal synchronized by the digital signal synchronizer, and an initial condition setter to initialize a predefined parameter of the digital signal synchronizer when the check result indicates that the decoding has been performed abnormally.

Accordingly, the digital signal manager detects whether the digital signals of the optical signal are decoded by the decoder normally, or whether the digital signals of the optical signal are synchronized in a stable status, thereby allowing realization of stable digital synchronization.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is a block diagram illustrating a coherent optical receiver according to an exemplary embodiment.

FIG. 2 is a block diagram illustrating a coherent optical receiver according to another exemplary embodiment.

FIG. 3 is a block diagram illustrating a digital synchronization device which determines whether to synchronize digital signals according to the status of the digital signals to be decoded in a coherent optical receiver according to an exemplary embodiment.

FIG. 4 is a block diagram illustrating a digital signal synchronizer according to an exemplary embodiment.

FIG. 5 is a block diagram illustrating a digital synchronization device which determines whether to synchronize digital signals according to the status of the digital signals to be decoded in a coherent optical receiver, according to another exemplary embodiment.

FIG. 6 is a block diagram illustrating a digital synchronization device which determines whether to re-perform synchronization according to stability of a digital signal synchronized in a coherent optical receiver, according to an exemplary embodiment.

FIG. 7 is a block diagram illustrating a digital synchronization device which determines whether to re-form synchronization according to stability of a digital signal synchronized in a coherent optical receiver, according to another exemplary embodiment.

FIG. 8 is a graph illustrating a bit error rate of the optical signal from the digital synchronization device according to the exemplary embodiment.

Elements, features, and structures are denoted by the same reference numerals to throughout the drawings and the detailed description, and the size and proportions of some elements may be exaggerated in the drawings for clarity and convenience.

### DETAILED DESCRIPTION

The following detailed description is provided to assist the reader in gaining a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

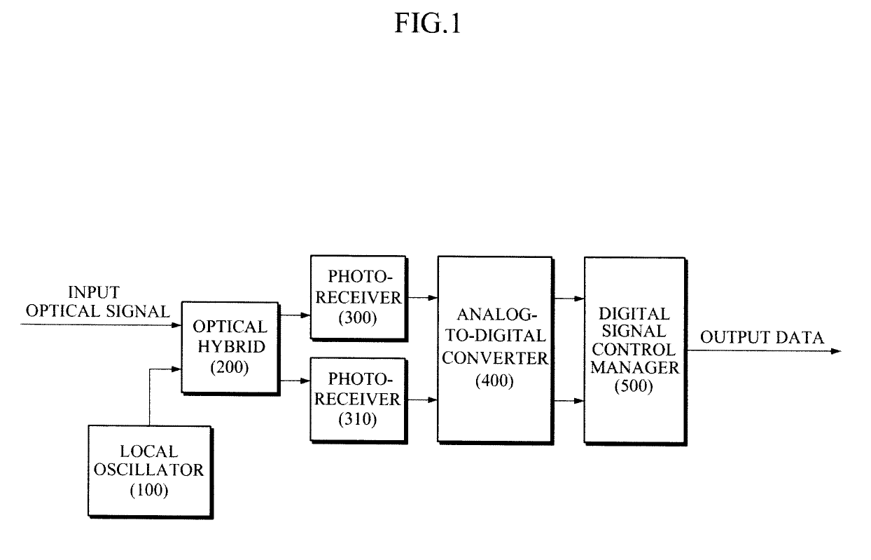

FIG. 1 is a block diagram illustrating a coherent optical receiver according to an exemplary embodiment. Referring to FIG. 1, the coherent optical receiver includes a local oscillator 100, an optical hybrid 200, photo-receivers 300 and 310, an analog-to-digital converter 400, and a digital signal control manager 500.

The local oscillator 100 outputs an optical signal of laser (hereinafter, referred to as a laser optical signal). The optical hybrid 200 combines an optical signal received through an optical fiber and the laser optical signal output from the local oscillator 100. Then, the optical hybrid 200 divides the combined optical signal into two output optical signals with a phase difference of 90 degrees and outputs the output optical signals to the photo-receivers 300 and 310, respectively. The photo-receivers 300 and 310 respectively receive the output optical signals from the optical hybrid 200, convert the output optical signals into electrical signals and output the electrical signals.

The analog-to-digital converter (ADC) 400 converts the electrical signals output from the photo-receivers 300 and 310 into digital signals.

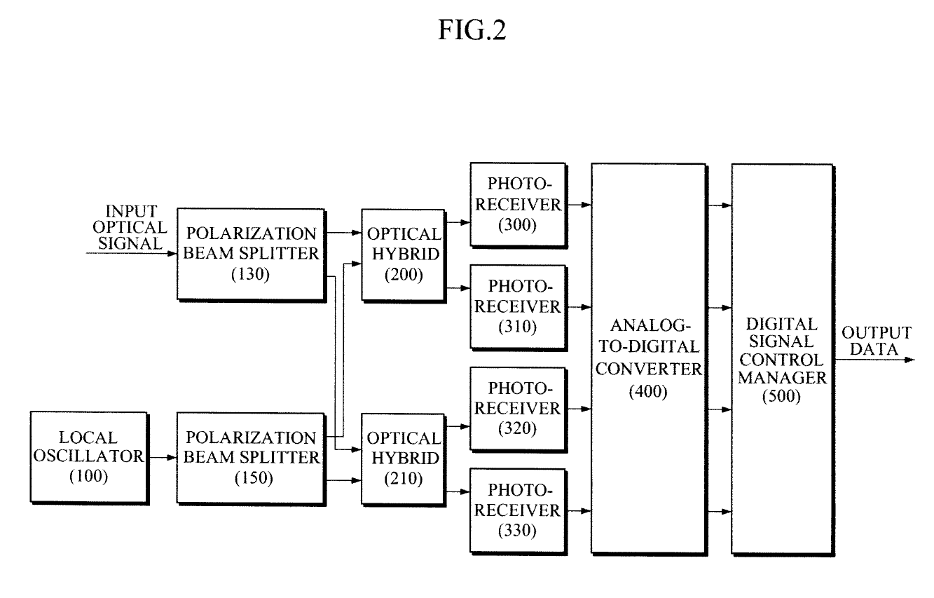

The digital signal control manager 500 combines the digital signals from the analog-to-digital converter 400 and synchronizes the combined digital signals to make the digital signal from the optical signal received through the optical fiber to be decoded and output normally. In other words, the digital signal control manager 500 uses synchronized digital signals to allow data of the optical signal received through the optical fiber to be output normally. The digital signal control manager 500 includes a digital synchronization device which will be described later. The coherent optical receiver may be configured as shown in FIG. 2 in order to compensate for an impairment related to polarization such as polarization mode dispersion (PMD) or polarization dependent loss (PML).

FIG. 2 is a block diagram illustrating a coherent optical receiver according to another exemplary embodiment. Referring to FIG. 2, the coherent optical receiver includes a local oscillator 100, polarization beam splitters 130 and 150, optical hybrids 200 and 210, photo-receivers 300, 310, 320, and 330, an analog-to-digital converter 400, and a digital signal control manager 500. The polarization beam splitter 130 splits an optical signal received through an optical fiber into x-polarization and y-polarization, and transmits the x- and y-polarizations to the respective optical hybrids 200 and 210. In addition, the polarization beam splitter 150 receives a laser optical signal output from the local oscillator 100, splits the received laser optical signal into x-polarization and y-polarization, and transmits the x- and y-polarizations to the respective optical hybrids 200 and 210. The optical hybrid 200 combines the x-polarizations of the optical signal and the laser optical signal from the respective polarization beam splitters 130 and 150 and the optical hybrid 210 combines the y-polarizations of the optical signal and the laser optical signal from the respective polarization beam splitters 130 and 150.

Thereafter, each of the optical hybrids 200 and 210 divides the combined optical signal into two output optical signals with a phase difference of 90 degrees. The photo-receivers 300 and 310 connected with the optical hybrid 200 receive the output optical signals of x-polarizations with a phase difference of 90 degrees, convert the received output optical signals into electrical signals and output the converted electrical signals. In a similar manner, the photo-receivers 320 and 330 connected with the optical hybrid 210 receive the output optical signals of y-polarizations with a phase difference of 90 degrees, convert the received optical signals into electrical signals and output the converted electrical signals.

Then, the analog-to-digital converter 400 converts the electrical signals received from the photo-receivers 300, 310, 320 and 330 into digital signals. The digital signal control manager 500 combines the converted digital signals from the photo-receivers 300, 310, 320, and 330, and performs synchronization on the combined digital signal from the photo-receivers 300, 310, 320 and 330 to make the digital signal of the optical signal received through the optical fiber to be decoded and output normally. That is, the digital signal control manager 500 uses the synchronized digital signal such that data of the optical signal received through the optical fiber can be output normally. As such, the coherent optical receiver does not need to make the polarization of the optical signal received through the optical fiber identical with the polarization of the laser optical signal output from the local oscillator 100, and can compensate for polarization impairment such as polarization mode dispersion (PMD) and polarization dependent loss (PDL). Hereinafter, description of a digital synchronization device in the digital signal control manager 500 for digital signal synchronization will be provided.

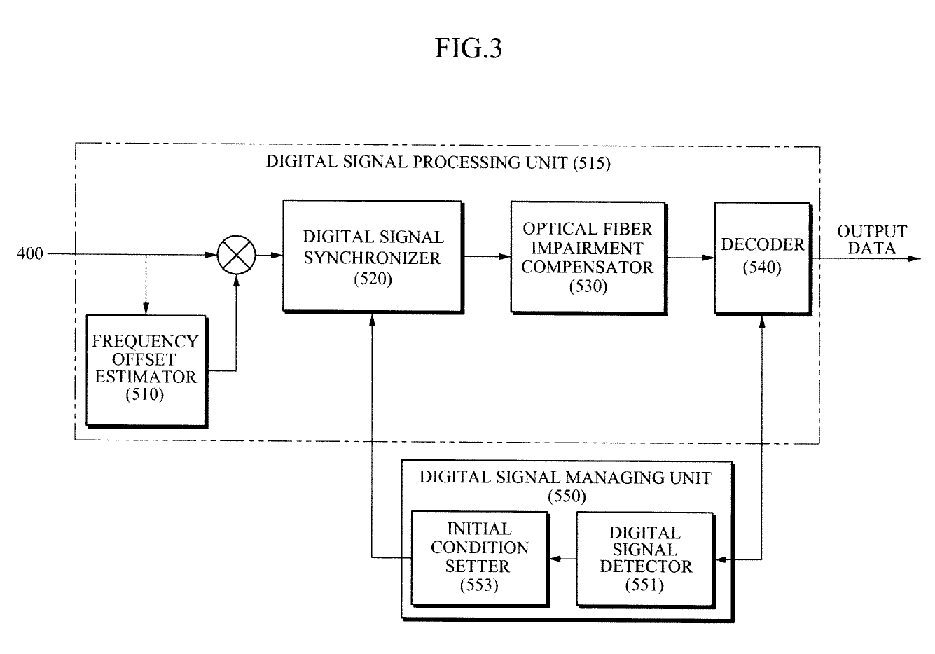

FIG. 3 is a block diagram illustrating a digital synchronization device of a coherent optical receiver according to an exemplary embodiment. The digital synchronization device determines synchronization according to the status of a digital signal to be decoded.

As illustrated in FIG. 3, the digital synchronization device includes a digital signal processing unit 515 and a digital signal managing unit 550. The digital signal processing unit 515 performs synchronization on a digital signal of an output signal generated by interfering an optical signal received through an optical fiber with a laser optical signal output from a local oscillator 100 (see FIG. 1 or 2), and performs decoding using the synchronized digital signal. The digital signal processing unit 515 includes a frequency offset estimator 510, a digital signal synchronizer 520, an optical fiber impairment compensator 530, and a decoder 540.

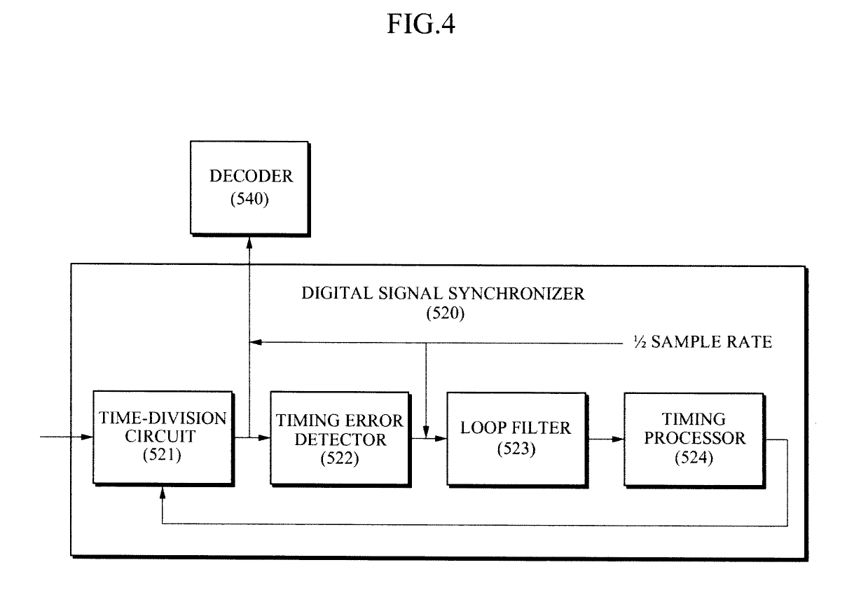

The frequency offset estimator 510 compensates for a frequency difference between the optical signal received through the optical fiber and the laser optical signal output from the local oscillator 100. More specifically, the optical signal and the laser optical signal are converted into digital signals by the analog-to-digital converter 400 (see FIG. 1 or 2), and accordingly their original frequencies are changed. Thus, the frequency offset estimator 510 estimates the phase difference between the original optical signal and the original laser optical signal, and compensates for the estimated phase difference. The digital signal synchronizer 520 performs synchronization on the frequency compensated digital signal. The digital signal synchronizer 520 may be configured as shown in FIG. 4.

FIG. 4 is a block diagram illustrating a digital signal synchronizer 520 according to an exemplary embodiment. Referring to FIG. 4, the digital signal synchronizer 520 includes a time-division circuit 521, a timing error detector 522, a loop filter 523, and a timing processor 524.

The time-division circuit 521 computes intermediate values between sample values of the digital signal which has been compensated for the frequency difference by the frequency offset estimator 510. That is, the time-division circuit 521 generates a new sequence of digital signal samples using a minimum error value which is feedback by each of elements which will be described later. The generated sequence of digital signal samples comes to be the same as a value sampled in the middle of a symbol of a transmission signal.

The timing error detector 522 computes a timing error caused by the time-division circuit 521 calculating the sample values of the digital signal. For example, in the case of a phase shift keying (PSK) signal, the timing error detector 522 computes the error based on the characteristic of the PSK signal by use of an equation below.

e(mₖ)=Re{y(mₖTₛ+μₖTₛ)y(mₖTₛ+μₖTₛ)}=Re{(mₖTₛ+μₖTₛ)[y((mₖ+1)Tₛ+μₖTₛ)−y(mₖ−1)Tₛ+μₖTₛ)]} Equation 1

The loop filter 523 which is configured to have a proportional integral structure calculates an output value using the error obtained by Equation 1. The timing processor 524 feeds back to the time-division circuit 521 such that the error is minimized from the output value of the loop filter 523. Consequently, the time-division circuit 521 generates a new sequence of digital signal samples such that the feedback error can be minimized, and the generated sequence of digital signal samples becomes identical with a value sampled in the middle of a symbol, so that the digital signal is synchronized.

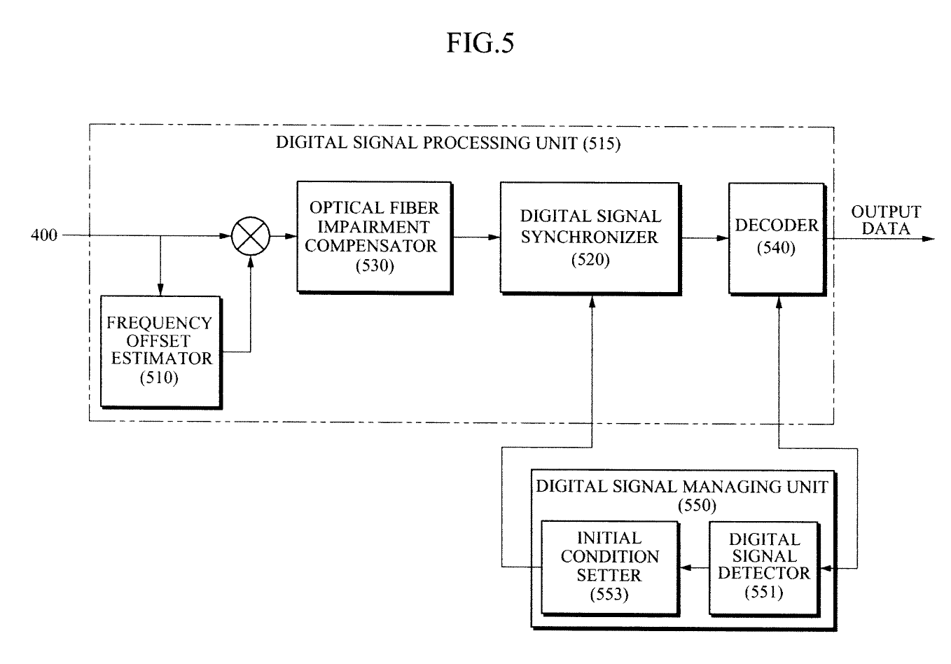

The optical fiber impairment compensator 530 checks the occurrence of impairment of the optical signal, which is converted into a digital signal, due to impairment components in the optical fiber and compensates for the identified impairment. Specifically, impairment such as chromatic dispersion and polarization mode dispersion may occur in the optical signal as transmitted through the optical fiber. Accordingly, the optical fiber impairment compensator 530 compensates for the impairment in the optical signal received through the optical fiber after the synchronization is performed on the digital signal by the digital signal synchronizer 520. Moreover, the optical fiber impairment compensator 530 may compensate for the impairment of the optical signal before the digital signal synchronizer 520 synchronizes clocks of the digital signal as shown in FIG. 5.

FIG. 5 is a block diagram illustrating a digital synchronization device of a coherent optical receiver according to another exemplary embodiment. The digital synchronization device determines synchronization of a digital signal according to the status of the digital signal to be decoded.

Referring to FIG. 5, an optical impairment compensator 530 compensates for impairment of an optical signal received through an optical fiber when a frequency difference between the optical signal and a laser optical signal which are converted into a digital signal is compensated for by a frequency offset estimator 510. As described above, since the optical signal is transmitted through the optical fiber, impairment such as chromatic dispersion and polarization mode dispersion may occur in the optical signal. Thus, the optical fiber impairment compensator 530 compensates for the impairment of the optical signal, and a digital signal synchronizer 520 synchronizes clocks of the digital signal of which impairment has been compensated for.

As such, once the clocks of the digital signal are synchronized by the digital signal synchronizer 520 either after or before the impairment of the optical signal is compensated for, a decoder 540 decodes the digital signal of the optical signal received through the optical fiber using the synchronized digital signal.

The digital signal managing unit 550 controls data of the optical signal received through the optical fiber to be output normally according to the synchronized digital signal. The digital signal managing unit 550 may include a digital signal detector 551 and an initial condition setter 553. The digital signal detector 551 examines whether the synchronized digital signal is decoded normally by the decoder 540 and controls the operation of the decoder 540 according to the examination result. If it is determined that the synchronized digital signal is decoded abnormally by the decoder 540, the digital signal detector 551 stops the operation of the decoder 540. Thereafter, the initial condition setter 553 initializes a condition initially set in the digital signal synchronizer 520.

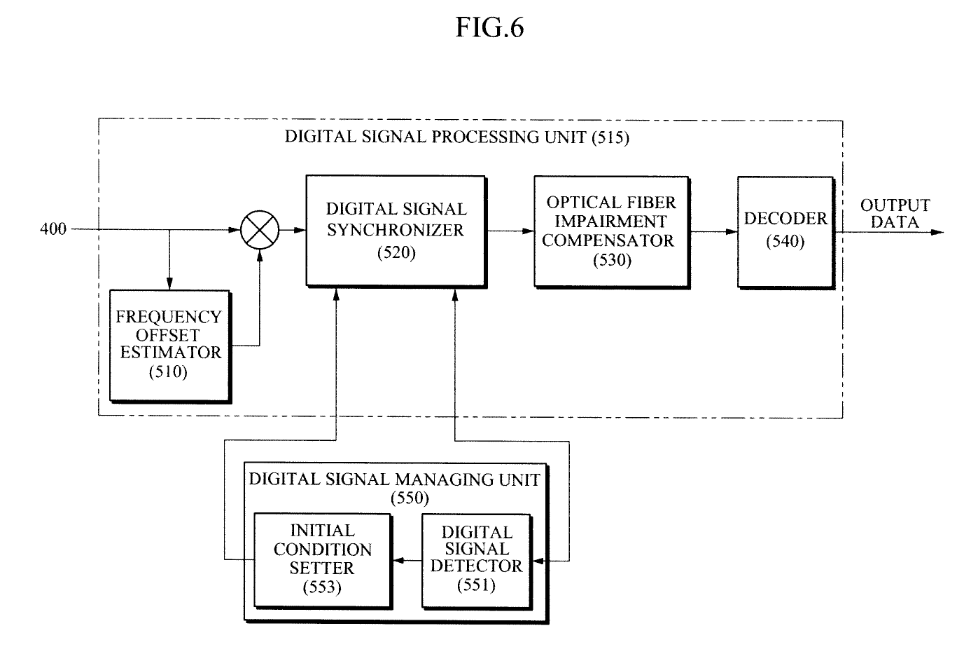

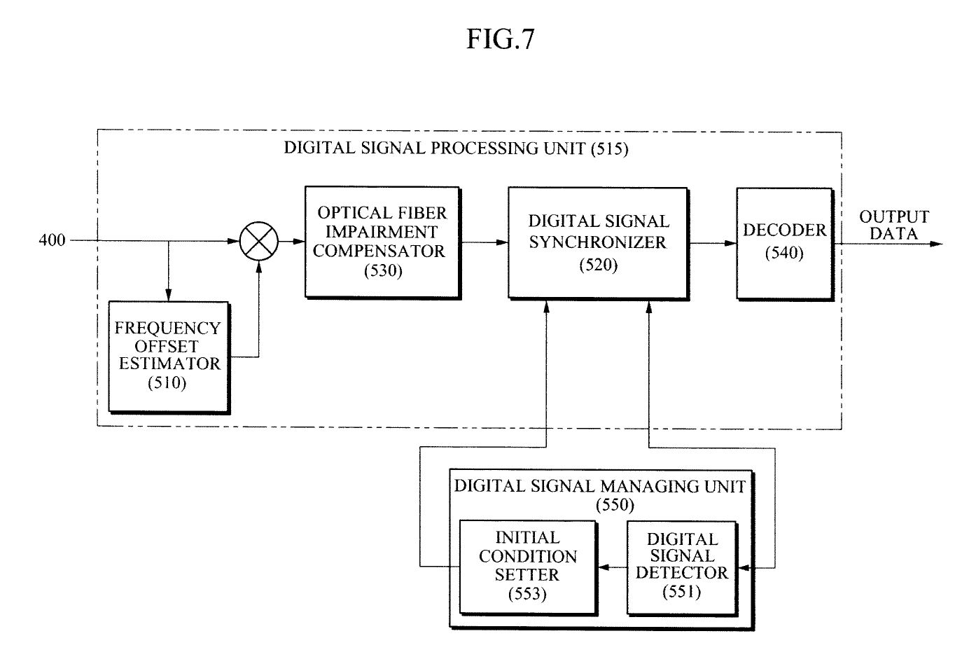

Thus, the digital signal synchronizer 520 re-performs the synchronization on the digital signal, so that the decoder 540 decodes the digital signal normally and accordingly the data of the optical signal can be output normally. In another general aspect, the digital signal managing unit 550 monitors the digital signal synchronizer 520 as shown in FIG. 6 or 7.

FIG. 6 is a block diagram illustrating a digital synchronization device of a coherent optical receiver according to an exemplary embodiment. The digital synchronizer to determines whether to re-perform synchronization according to stability of a synchronized digital signal. Additionally, FIG. 7 is a block diagram illustrating a digital synchronization device of a coherent optical receiver according to another exemplary embodiment. The digital synchronization device determines whether to re-form synchronization according to stability of a synchronized digital signal.

As illustrated in FIG. 6, a digital signal detector 551 of a digital signal managing unit 550 determines stability of a synchronized digital signal with reference to a changed parameter of the digital signal synchronized by the digital signal synchronizer 520. If the digital signal detector 551 determines that the synchronized digital signal is instable, an initial condition setter 553 initializes a parameter predefined in the digital signal synchronizer 520. As such, the digital signal synchronizer 520 re-performs stable synchronization on a digital signal using information of the initialized parameter. After the re-synchronization, an optical fiber impairment compensator 530 compensates for impairment of the optical signal which has been converted into the digital signal. Thereafter, the decoder 540 decodes the digital signal normally after the impairment of the digital signal is compensated for by the optical fabric impairment compensator 530 and then synchronization is performed on the digital signal. Thus, data of the optical signal can be output normally.

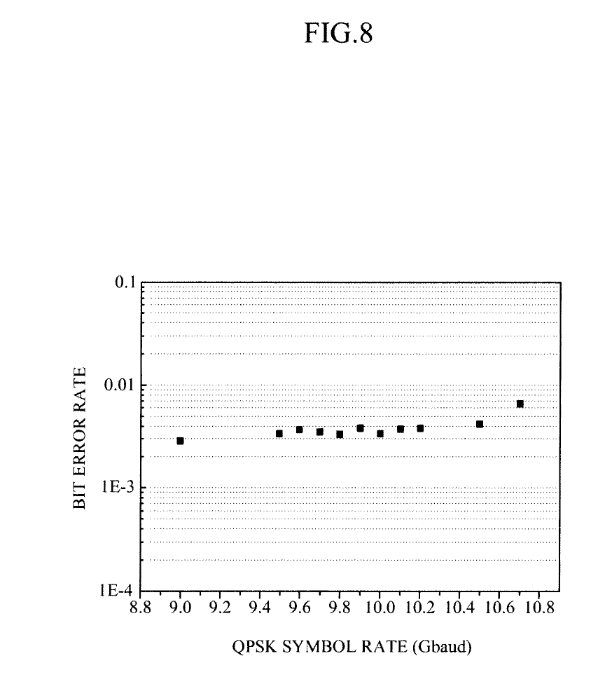

In another exemplary embodiment, as shown in FIG. 7, after impairment of digital signal of an optical signal is compensated for by the optical fabric impairment compensator 530 and then synchronization of the digital signal is performed by the digital signal synchronizer 520, the digital signal detector 551 may determine stability of the synchronized digital signal with reference to a changed parameter of the synchronized digital signal. When the digital signal detector 551 determines that the synchronized digital signal is instable, the initial condition setter 553 initializes a parameter predefined in the digital signal synchronizer 520. Accordingly, the digital signal synchronizer 520 re-performs the stable synchronization of digital signals using information of the initialized to parameter. Hence, stable digital synchronization with respect to the optical signal received through the optical fiber can be realized in a wider range of symbol rates as shown in FIG. 8.

FIG. 8 is a graph illustrating a bit error rate of the optical signal from the digital synchronization device according to the exemplary embodiment. The optical signal received through the optical fiber is modulated in quaternary phase shift keying (QPSK), and its symbol rate is set about 10 Gbaud. As shown in FIG. 8, while the symbol rate in QPSK changes significantly from 9.0 to 10.7 Gbaud, the bit error rate remains almost the same. That is, the digital synchronization device allows the stable digital synchronization with respect to an incoming optical signal in a wide range of symbol rates.

Accordingly, as described above, the digital signal synchronization device of the coherent optical receiver allows more stable digital synchronization with respect to an incoming optical signal at a wider range of symbol rates, compared to conventional synchronization methods.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A digital signal synchronization device comprising:
a digital signal processing unit to perform synchronization on a digital signal of an output optical signal generated by interfering an optical signal received through an optical fiber with an optical signal of laser (hereinafter, referred to as a laser optical signal) output from a local oscillator and to perform decoding using the synchronized digital signal; and
a digital signal managing unit to monitor the digital signal processing unit to output data of the optical signal normally, which has been received through the optical fiber, to according to the synchronized digital signal.

2. The digital signal synchronization device of claim 1, wherein the digital signal processing unit comprises:
a frequency offset estimator to compensate the digital signal for a frequency difference between the optical signal received through the optical fiber and the laser optical signal and to combine the compensated digital signals;
a digital synchronizer to synchronize the compensated and combined digital signal; and
a decoder to decode the digital signal with reference to the synchronized digital signal.

3. The digital signal synchronization device of claim 2, wherein the digital signal processing unit further comprises an optical fiber impairment compensator to check whether the digital signal generated from the optical signal received through the optical fiber has impairment due to impairment components in the optical fiber and compensate for the impairment according to the check result.

4. The digital signal synchronization device of claim 2, wherein the optical fiber impairment compensator compensates for the impairment using the digital signal synchronized by the digital signal synchronizer.

5. The digital signal synchronization device 2, wherein the optical fiber impairment compensator compensates for the impairment using the digital signal of which frequency is compensated for by the frequency offset compensator.

6. The digital signal synchronization device of claim 2, wherein the digital signal managing unit comprises:
a digital signal detector to check whether the synchronized digital signal is decoded normally and to control operations of the decoder according to the check result; and
an initial condition setter to initialize a predefined condition of the digital signal synchronizer when the check result indicates that the decoding has been performed abnormally.

7. The digital signal synchronization device of claim 2, wherein the digital signal managing unit comprises:
a digital signal detector to determine stability of the synchronized digital signal with reference to a changed parameter of the digital signal synchronized by the digital signal synchronizer; and
an initial condition setter to initialize a predefined parameter of the digital signal synchronizer when the check result indicates that the decoding has been performed abnormally.

8. A coherent optical receiver comprising:
an optical hybrid to receive an optical signal transmitted through an optical fiber and an optical signal of laser (hereinafter, referred to as “laser optical signal”) output from a local oscillator and to output the optical signal and the laser optical signal such that the optical signal and the laser optical signal have a predetermined phase difference.
one or more photo-receivers, each to transform the optical signal and the laser optical signal output from the optical hybrid at a predetermined phase difference into electrical signals;
an analog-to-digital converter to convert the electrical signals transformed from the optical signal and the laser optical signal into digital signals; and
a digital signal control manager to combine the digital signals converted from the optical signal and the laser optical signal and synchronize the combined digital signals and to decode the synchronized digital signals such that data of the optical signal can be output normally.

9. The coherent optical receiver of claim 8, wherein the optical hybrid outputs the optical signal and the laser optical signal with a phase difference of 90 degrees.

10. The coherent optical receiver of claim 8, wherein the digital signal control manager comprises:
a frequency offset estimator to compensate the digital signal for a frequency difference between the optical signal received through an optical fiber and the laser optical signal and to combine the compensated digital signals;
a digital signal synchronizer to synchronize the compensated and combined digital signal;
a decoder to decode the digital signals; and
a digital signal managing unit to control the digital signal such that data of the optical signal can be output normally according to the synchronized digital signal.

11. The coherent optical receiver of claim 10, wherein the digital signal control manager comprises an optical fabric impairment compensator to check whether the digital signal generated from the optical signal received through the optical fiber has impairment due to impairment components in the optical fiber and compensate for the impairment according to the check result.

12. The coherent optical receiver of claim 11, wherein the optical fiber impairment compensator compensates for the impairment either after or before the synchronization is performed by the digital signal synchronizer.

13. The coherent optical receiver of claim 10, wherein the digital signal manager comprises:
a digital signal detector to check whether the synchronized digital signal is decoded normally and control the decoder according to the check result; and
an initial condition setter to initialize a predefined condition of the digital signal synchronizer when the check result indicates that the decoding has been performed abnormally.

14. The coherent optical receiver of claim 10, wherein the digital signal manager comprises:
a digital signal detector to determine stability of the synchronized digital signal with reference to a changed parameter of the digital signal synchronized by the digital signal synchronizer; and
an initial condition setter to initialize a predefined parameter of the digital signal synchronizer when the check result indicates that the decoding has been performed abnormally.
